(19) United States
(12) Patent Application Publication
(10) Pub. No.: US 2026/0188280 A1
(43) Pub. Date: Jul. 2, 2026

(54) COMPENSATION METHOD, DEVICE, APPARATUS AND STORAGE MEDIUM FOR A DISPLAY PANEL

(71) Applicant: Xiamen Tianma Display Technology Co., Ltd., Xiamen (CN)

(72) Inventors: Qixin XU, Xiamen (CN); Ying Sun, Xiamen (CN); Qiang Chen, Xiamen (CN)

(73) Assignee: Xiamen Tianma Display Technology Co., Ltd., Xiamen (CN)

(21) Appl. No.: 19/190,830

(22) Filed: Apr. 28, 2025

(30) Foreign Application Priority Data
Dec. 30, 2024 (CN) 202411977141.9

(51) Int. Cl. G09G 5/10; G09G 3/3258

(52) U.S. Cl. CPC G09G 5/10; G09G 3/3258; G09G 2320/0233; G09G 2320/0626; G09G 2320/0673

(57) ABSTRACT

The present application discloses a compensation method, device, apparatus, and storage medium for a display panel, and the method includes: acquiring N areas to be compensated of the display panel, where the N areas to be compensated are determined and obtained based on a target scanning timing and a display blanking area of the display panel, where N is a positive integer; acquiring a first luminance parameter deviation between the N areas to be compensated and a normal area of the display panel when the display panel displays a picture with each of gray scale values at different luminance levels; and determining a target luminance compensation parameter of the display panel based on the first luminance parameter deviation, and performing the luminance compensation on the N areas to be compensated based on the target luminance compensation parameter.

### CROSS-REFERENCE TO RELATED APPLICATION

This application claims priority to Chinese Patent Application No. 202411977141.9, filed on Dec. 30, 2024, which is hereby incorporated by reference in its entirety.

### TECHNICAL FIELD

The present application relates to the technical field of display, and in particular to a compensation method, device and apparatus and storage medium for a display panel.

### BACKGROUND

With the rapid development of display technology, new types of display panels, such as OLED (Organic Light Emitting Diode) display panels and micro LED (Micro Light Emitting Diode) display panels, emerge in endlessly, and full screen display has become the trend of mobile display devices, such as mobile phones. However, the inventors of the present application have found that the current display panel is prone to the problem of non-uniformity luminance of the split screen in some scenes, thus resulting in a poor display effect of the display panel.

### SUMMARY

Embodiments of the present application provide a compensation method, device and apparatus and storage medium for a display panel, which can more fully achieve the uniformity of display luminance, so that the display effect of the display panel can be effectively improved.

In a first aspect, embodiments of the present application provide a compensation method for a display panel. The method includes: acquiring N areas to be compensated of the display panel, wherein the N areas to be compensated are determined and obtained based on a target scanning timing and a display blanking area of the display panel, where N is a positive integer; the target scanning timing comprises at least one of a first scanning timing and a second scanning timing, the first scanning timing being configured for resetting and scanning of a sub-pixel in the display panel and the second scanning timing being configured for bias adjustment scanning of a driving module in the sub-pixel; acquiring a first luminance parameter deviation between the N areas to be compensated and a normal area of the display panel when the display panel displays a picture with each of gray scale values at different luminance levels; and determining a target luminance compensation parameter of the display panel based on the first luminance parameter deviation, and performing the luminance compensation on the N areas to be compensated based on the target luminance compensation parameter.

In a second aspect, embodiments of the present application provide a compensation device for a display panel comprising a first acquisition module configured to acquire N areas to be compensated of the display panel, wherein the N areas to be compensated is determined and obtained based on a target scanning timing and a display blanking area of the display panel, where N being a positive integer; the target scanning timing comprises at least one of a first scanning timing and a second scanning timing, the first scanning timing being configured for resetting and scanning a plurality of sub-pixels in the display panel, and the second scanning timing being configured for bias adjustment and scanning a driving module in the sub-pixels; a second acquisition module configured to acquire a first luminance parameter deviations between the N areas to be compensated and a normal area of the display panel when the display panel displays a picture with each of gray scale values at different luminance levels; and a first compensation module configured to determine a target luminance compensation parameter of the display panel based on the first luminance parameter deviation, and to perform luminance compensation on the N areas to be compensated based on the target luminance compensation parameter.

In a third aspect, embodiments of the present application provide an electronic device including a processor, a memory, and a computer program stored in the memory and executable on the processor. The compensation method for the display panel provided in the first aspect is implemented when the computer program is executed by the processor.

In a fourth aspect, embodiments of the present application provide a computer-readable storage medium. The computer-readable storage medium stores a computer program, and the compensation method for the display panel provided in the first aspect is implemented when the computer program is executed by a processor.

### BRIEF DESCRIPTION OF THE DRAWINGS

In order to more clearly illustrate the technical schemes of embodiments of the present application, a brief description will be given below with reference to the need to be used in the embodiments of the present application. It is obvious that the drawings described below are only some embodiments of the present application, and for a person skilled in the art, other drawings can be obtained according to these drawings without involving any inventive effort.

FIG. 1 is a schematic structural view of a sub-pixel according to an embodiment of the present application;

FIG. 2 is a schematic view of a scanning scenario of a sub-pixel according to an embodiment of the present application;

FIG. 3 is a schematic view of a scanning scenario of a sub-pixel according to another embodiment of the present application;

FIG. 4 is a schematic flow view of a compensation method for a display panel according to an embodiment of the present application;

FIG. 5 is a schematic structural view of a sub-pixel according to another embodiment of the present application;

FIG. 6 is a schematic structural view of a sub-pixel according to yet another embodiment of the present application;

FIG. 7 is a timing view of a first scanning signal line and a second scanning signal line provided according to an embodiment of the present application;

FIG. 8 is a schematic flow view of a compensation method for a display panel according to another embodiment of the present application;

FIG. 9 is a schematic flow view of a compensation method for a display panel according to yet another embodiment of the present application;

FIG. 10 is a schematic flow view of a compensation method for a display panel according to still yet another embodiment of the present application;

FIG. 11 is a schematic flow view of a compensation method for a display panel according to even still yet another embodiment of the present application;

FIG. 12 is a schematic flow view of a compensation method for a display panel according to even still yet another embodiment of the present application;

FIG. 13 is a schematic structural view of a display panel according to an embodiment of the present application;

FIG. 14 is a schematic view of a reset voltage compensation according to an embodiment of the present application;

FIG. 15 is a schematic structural view of a display panel according to another embodiment of the present application;

FIG. 16 is a schematic view of a bias voltage compensation according to an embodiment of the present application;

FIG. 17 is a schematic structural view of a compensation device for a display panel according to an embodiment of the present application;

FIG. 18 is a schematic structural view of a compensation apparatus for a display panel according to an embodiment of the present application.

### DETAILED DESCRIPTION

Reference will now be made in detail to the features and exemplary embodiments of the various aspects of the present application, and in order that the objects, aspects, and advantages of the present application will become more apparent, a more particular description of the present application will be rendered by reference to specific embodiments thereof which are illustrated in the appended drawings. It should be understood that the specific embodiments described herein are intended for purposes of illustration only and are not intended to be limiting. It will be apparent to one skilled in the art that the present application may be practiced without some of these specific details. The following description of the embodiments is merely provided to provide a better understanding of the application and to illustrate examples of the present application.

It is noted that relational terms such as first and second, and the like, may be used solely to distinguish one entity or action from another entity or action without necessarily requiring or implying any actual such relationship or order between such entities or actions. Moreover, the terms “comprise”, “include”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element.

It is to be understood that the term “and/or” as used herein is merely an association that describes an associated object and that there may be three relationships, e.g. A and/or B, which may represent: there are three cases of A alone, A and B together, and B alone. In addition, the character “/”, as used herein, generally indicates that the context object is an “or” relationship.

It should be noted that the transistor in the embodiment of the present application may be an N-type transistor or a P-type transistor. For an N-type transistor and the on-level is high and the off-level is low. That is, when the gate of the N-type transistor is at a high level, the N-type transistor is turned on between the first electrode and the second electrode thereof; when the gate of the N-type transistor is at a low level, the N-type transistor is turned off between the first electrode and the second electrode thereof. For a P-type transistor, the on-level is low and the off-level is high. That is, when the control terminal of the P-type transistor is at a low level, the P-type transistor is turned on between the first electrode and the second electrode thereof; when the control terminal of the P-type transistor is at a high level, the P-type transistor is turned off between the first electrode and the second electrode thereof. In the specific implementation, the gate electrode of each of the above-mentioned transistors serves as the control electrode thereof, and according to the signal of the gate electrode of each transistor and the type thereof, the first electrode thereof may serve as the source electrode and the second electrode thereof may serve as the drain electrode, or the first electrode thereof may serve as the drain electrode and the second electrode thereof may serve as the source electrode, and no distinction is made here; furthermore, in the embodiments of the present application, the on-level and the off-level are both generally referred to, the on-power level referring to any level capable of turning on the transistor, and the off-power level referring to any level capable of turning off/turning off the transistor.

In embodiments of the present application, the term “electrically connected” may refer to a direct electrical connection between two components, or may refer to an electrical connection between two components via one or more other components.

It will be apparent to those skilled in the art that various modifications and variations can be made in the present application without departing from the spirit or scope of the application. Thus, it is intended that the present application cover the modifications and variations of the present application provided they come within the scope of the appended claims and their equivalents. It should be noted that the embodiments provided in the examples of the present application can be combined with each other in a non-conflicting manner.

Before setting forth the technical solutions provided by the embodiments of the present application, in order to facilitate the understanding of the embodiments of the present application, the present application first specifically describes the problems existing in the related art: due to the existence of the display blanking area in the display panel, there is a difference in the internal load under different display stages of the display panel, so that the degree of initialization of the light-emitting device is inconsistent, and/or the degree of bias adjustment of the threshold voltage Vth of the driving module is inconsistent, so that the display panel appears dark striations, resulting in a picture with split-screen.

Specifically, in actual display panel display, a pixel circuit generally outputs a driving current to drive a light-emitting element to emit light, so that the display device achieves the purpose of displaying a picture. When the pixel circuit drives the light-emitting element to emit light, the potential of the control terminal of the driving module in the pixel circuit may be greater than the potential of the second terminal of the driving module, and this setting for a long-term may cause a shift in the threshold voltage Vth of the driving module, thereby affecting the driving current flowing into the light-emitting element, and causing a problem of flicker or the like.

FIG. 1 is a schematic structural view of a sub-pixel. As shown in FIG. 1, a bias adjustment module may be added to the pixel circuit in order to improve the bias problem of the threshold voltage Vth of the driving module. A control terminal of the bias adjustment module is electrically connected to the scanning signal line, a first terminal of the bias adjustment module is electrically connected to a corresponding bias voltage terminal, a second terminal of the bias adjustment module is electrically connected to a first terminal of the driving module, and the bias voltage on the bias voltage terminal is derived from the display driving chip. The bias adjustment module is turned on under the control of the scanning signal line and transmits the bias voltage on the bias voltage terminal to the first terminal of the driving module. Since the driving module is turned on, the bias voltage on the bias voltage terminal is transmitted to the second terminal of the driving module via the driving module, so that the potential of the second terminal of the driving module is higher than or equal to the potential of the control terminal of the driving module, thereby adjusting the bias state of the threshold voltage Vth of the driving module.

As shown in FIG. 1, the pixel circuit may further include a reset module, and the reset module and the bias adjustment module may be controlled by a scanning signal line in common or may be controlled by different scanning signal lines respectively. A control terminal of the reset module may be electrically connected to the scanning signal line, a first terminal of the reset module may be electrically connected to a reset voltage terminal, and a bias voltage on the bias voltage terminal is derived from the display driving chip. The second terminal of the reset module can be electrically connected to the first electrode of the light-emitting element D, and the reset module is configured to initialize the first electrode of the light-emitting element D, so as to facilitate the timely removal of residual charges of the first electrode of the light-emitting device and to avoid residual pictures or artifacts.

In order to better adjust the bias state of the threshold voltage Vth of the driving module, the scanning signal provided by the same scanning signal line may include a plurality of enable levels, usually during a picture refresh period. That is, during a picture refresh period, the bias adjustment module can be turned on multiple times to adjust the bias state of the threshold voltage Vth of the driving module. Since the reset module and the bias adjustment module are controlled by the scanning signal line in common, the reset module is also turned on multiple times within a picture refresh period/image frame, and the first electrode of the light-emitting element D is initialized multiple times. The scanning signal line may provide a scanning signal for one or more rows of pixel circuits.

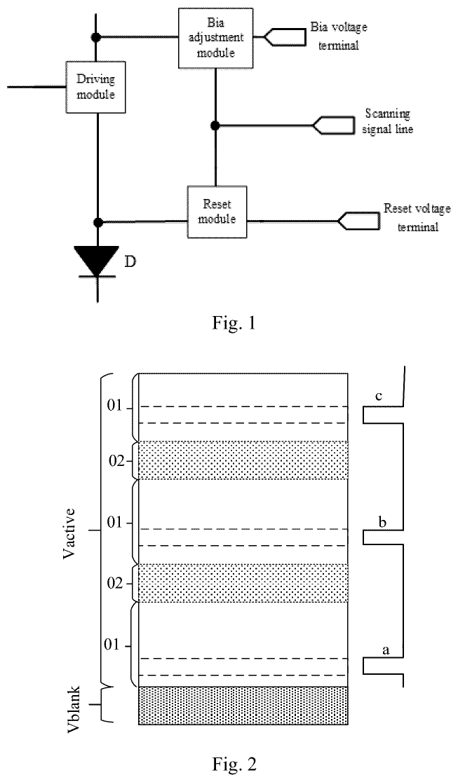

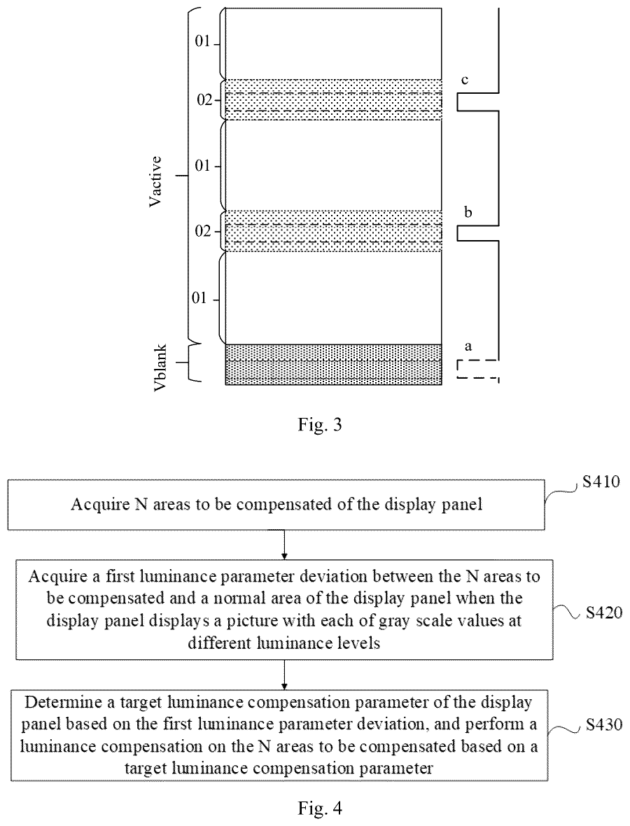

With reference to FIGS. 2 and 3, which illustrate the in-plane load effect of a display blanking area in a display panel on different display stages of the display panel. A plurality of rows of pixel circuits are arranged in a display area of the display panel, and a scanning signal provided by a scanning signal line during a picture refresh period includes a plurality of active pulses. When the scanning signal is an active pulse, the bias adjustment module and the reset module in the corresponding row pixel circuit are turned on respectively in response to the pulse signal of the scanning signal, adjusting the bias state of the threshold voltage Vth of the driving module and initializing the first electrode of the light-emitting element D.

For example, the scanning signals provided with the same scanning signal line within a picture refresh period include three active pulses (for providing an enable level): pulse a, pulse b, and pulse c. For example, one pulse width may correspond to a scan time of 30 rows of pixel circuits. A picture refresh cycle includes an active phase and a blanking phase, and the display panel includes a display active area Vactive area and a display blanking area Vblank area/porch area. After the operation of the pixel circuit is stable, in FIG. 2, the pulse a, the pulse b, and the pulse c in the scanning signal are all in the Vactive region, which is equivalent to the pixel circuit having three first regions 01 in the Vactive region initializing the first electrode of the light-emitting element D. For example, at this moment, the load in the display region is the load corresponding to the 90 rows of pixel circuits.

As shown in FIG. 3, the pulse a, the pulse b, and the pulse c of the scanning signal move downwards over time, and one pulse of the scanning signal (such as the pulse a) enters the Vblank region, resulting in the pixel circuit in the Vactive region only having two second regions 02 performing the initialization of the first electrode of the light-emitting element D. For example, when the load in the display region is the load corresponding to the pixel circuit of 60 rows. This results in a different number of rows of pixels being actively scanned in the Vactive area during different periods of time, resulting in a different in-plane load of the display panel. When pulse a, pulse b, and pulse c each provide an enable level for a row of pixels in the Vactive region, the in-plane load corresponds to 90 rows of pixels. When any one of the pulse a, the pulse b and the pulse c is scanned to the Vblank region, the number of pixel rows corresponding to the in-plane load decreases, so that the reset voltage received by the pixel circuit changes from a negative voltage to more negative, and the bias voltage changes from a positive voltage to more positive, thereby causing the luminance in the second region 02 to be dark, so that a display panel with a split-screen problem occurs.

In view of the above-mentioned research findings of the inventors, in order to solve the problems of the prior art, the embodiments of the present application provide a compensation method, device, apparatus, and storage medium for a display panel. It should be noted that the examples provided herein are not intended to limit the scope of the present application.

A compensation method for a display panel according to an embodiment of the present application will be described below.

Refer to FIG. 4, which is a schematic flow view of a compensation method for a display panel according to an embodiment of the present application. The display panel may be an AMOLED (Active-Matrix Organic Light-Emitting Diode), an OLED, or the like. It will be appreciated by those skilled in the art that in other implementations of the present application, the display panel may also be a micro light emitting diode display panel, a quantum dot display panel, etc.

In S410, N areas to be compensated of the display panel are acquired, which are determined and obtained based on a target scanning timing and a display blanking area of the display panel, where N is a positive integer and the target scanning timing includes at least one of a first scanning timing and a second scanning timing. The first scanning timing is configured for resetting and scanning of a sub-pixel in the display panel, and the second scanning timing is configured for bias adjustment and scanning of a driving module in the sub-pixel.

In S420, a first luminance parameter deviation between the N areas to be compensated and a normal area of the display panel is acquired when the display panel displays a picture with each of gray scale values at different luminance levels.

In S430, a target luminance compensation parameter of the display panel is determined based on the first luminance parameter deviation, and a luminance compensation is performed on the N areas to be compensated based on a target luminance compensation parameter.

Specific implementations of the S410 to S430 will be described in detail below.

In S410, it can be seen from the foregoing description that the display panel performs reset compensation or bias voltage compensation multiple times in one image frame. When the display panel performs reset compensation or bias voltage compensation in a specific area, the presence of the Vblank area/porch area causes a load variation in the lower part of the specific area, thereby causing voltage fluctuation, so that luminance deviation occurs in the specific area, and thus a split-screen phenomenon occurs.

Based on this, the target scanning timing of the display panel is predetermined in the present application. The target scanning timing includes at least one of a first scanning timing and a second scanning timing. The first scanning timing is configured for resetting and scanning of a sub-pixel in the display panel, and the second scanning timing is configured for bias adjustment and scanning of a driving module in the sub-pixel. The reset scan and the bias adjustment scan may or may not be set in synchronization as described above.

The scanning timing adopted by different display panels may vary, and accordingly, a split-screen phenomenon of non-uniformity luminance and darkness in an actual display panel occur, such as the above-mentioned tri-split-screen of a display panel. Alternatively, in other embodiments, the display panel may be divided into two panels, four panels, etc. depending on the scanning timing, which is not critical here.

Next, according to the target scanning timing of the display panel and the display blanking area described above, the N areas to be compensated of the display panel can be determined and obtained. The N areas to be compensated may, for example, be such that the display panel described above clearly presents dark striae areas, i.e. the two second areas 02 in FIG. 3, which are actually associated with the target scanning timing of the display panel and the display blanking area.

When the number of the scanning pulses in the target scanning timing is different, the position and number of the areas to be compensated are different. When there is a difference in the display blanking area, the width in the column direction of each area to be compensated is easily affected. Therefore, it is necessary to synthesize the target scanning timing and the information for displaying the blanking area when the area to be compensated is determined in the early stage.

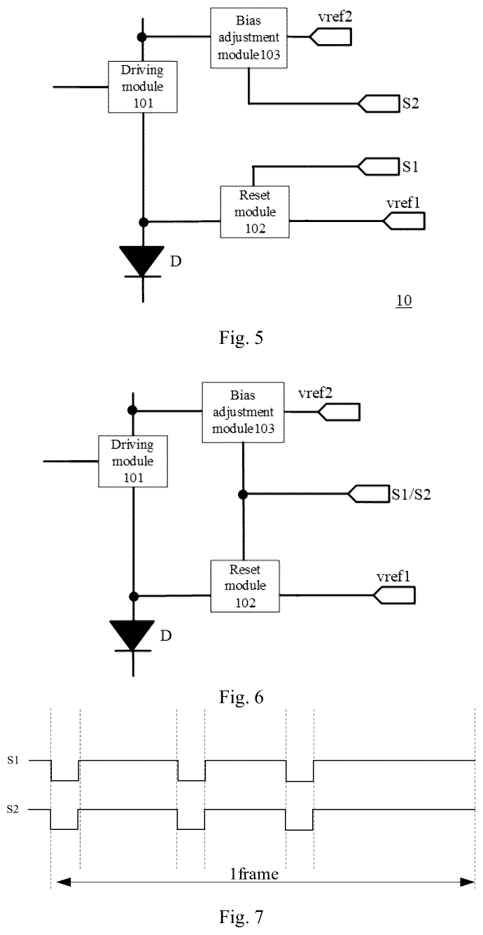

In some more specific embodiments of the present application, as shown in FIG. 5, the display panel includes a plurality of sub-pixels arranged in an array, the plurality of sub-pixels including a pixel circuit and a light-emitting device D, and the pixel circuit including a reset module 102.

A control terminal of the reset module 102 is electrically connected to the first scanning signal line S1, a first terminal of the reset module 102 is electrically connected to a corresponding reset voltage terminal vref1, and a second terminal of the reset module 102 is electrically connected to a corresponding light-emitting device D.

The first scanning timing is the scanning timing of the first scanning signal line S1.

As shown in FIG. 5, the present embodiment describes the origin of the first scanning timing of the display panel. The pixel circuit includes a reset module 102. The reset module 102 is turned on under the control of the first scanning signal line S1 in the reset stage of the pixel circuit and transmits the reset voltage provided by the reset voltage terminal vref1 to the second terminal of the reset module 102 to realize the initialization of the light-emitting device D, thereby facilitating the timely removal of residual charges in the light-emitting device D and avoiding picture residues or artifacts. Within an image frame, the first scanning signal line S1 may include a plurality of enable level/active pulses. That is, within an image frame, the reset module 102 may be turned on multiple times to initialize the light-emitting device.

The scanning timing of the first scanning signal line S1 is a first scanning timing, and the first scanning signal line S1 can provide scanning signals for pixel circuits in a plurality of rows of the sub-pixels.

It is added that the second terminal of the reset module 102, when electrically connected to the light-emitting device D, may be specifically electrically connected to a first electrode of the light-emitting device D, such as an anode, thereby facilitating more efficient adjustment of the initialization of the light-emitting device D. The light-emitting element D is, for example, an OLED (Organic Light Emitting Diode), a QLED (Quantum Dot Light Emitting Diodes), a micro LED (Micro Light Emitting Diodes), or the like.

In some more specific embodiments of the present application, and with reference to FIG. 5, the pixel circuit described above includes a driving module 101 and a bias adjustment module 103.

The driving module 101 is configured to drive the light-emitting device D to emit light.

A control terminal of the bias adjustment module 103 is electrically connected to the second scanning signal line S2, a first terminal of the bias adjustment module 103 is electrically connected to a corresponding bias voltage terminal vref2, and a second terminal of the bias adjustment module 103 is electrically connected to a first terminal or a second terminal of the driving module 101.

The second scanning timing is the scanning timing of the second scanning signal line S2.

As shown in the drawing, the present embodiment describes the origin of the second scanning timing of the display panel. When the light-emitting element D is driven to emit light, the potential of the control terminal of the driving module 101 may be greater than the potential of the first terminal or the second terminal of the driving module 101, and this setting for a long-term may cause polarization of ions inside the driving module 101, resulting in a shift of the threshold voltage Vth of the driving module 101, thereby affecting the driving current flowing into the light-emitting element D so that the light-emitting display effect is poor.

Based on this, in order to improve the threshold voltage shift problem of the driving module 101, the present embodiment introduces the bias adjustment module 103. Thus, in the bias stage of the pixel circuit, the bias adjustment module 103 is turned on under the control of the second scanning signal line S2, and transmits the bias voltage provided by the bias voltage terminal vref2 to the second terminal of the bias adjustment module 103, so as to realize the potential adjustment of the first terminal or the second terminal of the driving module 101, thereby adjusting the bias state of the threshold voltage Vth of the driving module 101.

In the present embodiment, the scanning timing of the second scanning signal line S2 is the second scanning timing, and the second scanning signal line S2 can provide scanning signals for the pixel circuits in one or more rows of sub-pixels. For example, when the pixel circuit in the i^{th} row of sub-pixels performs bias voltage adjustment for the driving module in response to the enable level of the second scanning signal line S2, the other row of pixel circuits connected to the same second scanning signal line S2 as the i^{th} row of pixel circuits may also perform bias state adjustment for the corresponding driving module 101 in response to its enable level, where i is a positive integer.

Furthermore, in order to sufficiently reduce the number of signal lines and improve the signal line multiplexing rate, as shown in FIG. 6, the first scanning signal line S1 is also served as the second scanning signal line S2. The first scanning timing is the same as the second scanning timing.

In this embodiment, the reset module 102 and the bias adjustment module 103 in the same pixel circuit can be controlled by the same first scanning signal line S1 or the same second scanning signal line S2, and the reset stage coincides with the bias adjustment stage, so as to realize the full utilization of the scanning signal lines in the display panel.

According to some embodiments of the present application, optionally, an image frame of the display panel includes a display active area and a display blanking area. The N areas to be compensated include a plurality of pixel lines.

The pixel rows in the N areas to be compensated are those pixel rows in the display active area that receives the active level of the target scanning timing in the case where the active level of the target scanning timing is scanned to the display blanking area.

In the present embodiment, the rows of pixels in the N areas to be compensated are further defined. That is, the pixel rows to be compensated are actually the rows of pixels in the active area receiving the enable level of the target scanning timing in the display active area under the condition that the enable level of the target scanning timing exists in the display blanking area.

Due to the presence of the display blanking area, this part of the pixel rows to be compensated causes a load variation in the display area, and thus a reset voltage and a bias voltage fluctuation occur, so that the initialization degree of the light-emitting element and the bias adjustment degree of the driving module are affected, and finally a dark striae occurs in the display panel, resulting in a picture with split-screen. Therefore, the partial pixel rows are the pixel rows in the display active area which need to be compensated for luminance, and the area where the partial pixel rows are located is the area to be compensated.

According to some embodiments of the present application, optionally, the first scanning timing and the second scanning timing are the same. In one image frame, there are N+1 active pulses in the first scanning timing or the second scanning timing.

In this embodiment, the first scanning timing and the second scanning timing are the same. The reset scanning of the sub-pixels in the display panel and the bias adjustment scanning timing of the driving module in the sub-pixels are synchronized. In this case, the area to be compensated in the display panel is N, and the number of active pulses in the first scanning timing or the second scanning timing is N+1. The present embodiment shows the relationship between the number of active pulses of the scanning timing and the number of regions to be compensated.

For example, as shown in FIG. 7, in one image frame, when there are three active pulses in the first scanning timing or the second scanning timing, there will be two dark striae regions appearing in the display panel, i.e. there are two areas to be compensated, resulting in the display panel exhibiting the aforementioned tri-split-screen. For another example, if there are two active pulses in the first scanning timing or the second scanning timing, a dark striae area will appear on the display panel, i.e. there is one area to be compensated, resulting in the display panel exhibiting the dual-split-screen.

In S420, when the display panel displays a picture with each of gray scale values at different luminance levels, the first luminance parameter deviations between the N areas to be compensated and the normal area of the display panel are acquired respectively.

In the field of display technology, the distribution of gray scale values may be different at different luminance levels. The luminance level refers to the actual luminance level that can be output from the display panel, and determines the actual luminance output range of the display panel. The luminance level is higher, the bright-dark contrast that can be displayed by the display panel is stronger, and the level sense of the image is richer. There are multiple gray levels at different luminance levels, respectively. The gray level is higher, and the variation in luminance that the display panel is able to exhibit is finer.

In the present embodiment, when the display panel displays a picture with each of gray scale values at different luminance levels, for example, a luminance test between the area to be compensated and the normal area of the display panel is performed at 128 grayscale at a low luminance level or at 255 grayscale at a high luminance level, respectively, so as to obtain the first luminance parameter deviation between the area to be compensated and the normal area. The measured deviation of the first luminance parameter may be different at different gray scale values at different luminance levels. The gray scale value described above may be a specified gray scale binding point value or may be selected based on actual test requirements.

When testing the luminance, in the present application, the luminance distribution can be evaluated by capturing an image of a display panel using an image acquisition system and evaluating the luminance distribution in combination with software analysis, so as to obtain the luminance parameters of the area to be compensated and a normal area. In this way, the first luminance parameter deviation is obtained by calculating the luminance difference between the area to be compensated and the normal area. Alternatively, in other embodiments, luminance deviations may be measured using a luminance meter, spectroradiometer, or the like and are not strictly limited herein.

It needs to be supplemented that when the luminance of the area to be compensated is collected, the average luminance of the area can be calculated after the luminance of each pixel point in the area to be compensated is collected, or the luminance of the central pixel point can be selected as the luminance of the area to be compensated. The luminance test of the normal area is similar to this and will not be described in detail herein.

In S430, a target luminance compensation parameter of the display panel is determined based on the first luminance parameter deviation, and the luminance compensation on the N areas to be compensated is performed based on the target luminance compensation parameter.

In this embodiment, after obtaining the above-mentioned first luminance parameter deviation, the target luminance compensation parameter of the area to be compensated in the display panel can be determined according to the luminance deviation situation. In this way, in the actual display operation, the luminance compensation is performed on the area to be compensated, and the dark striae distribution of the display panel can be effectively alleviated, so that the display uniformity can be improved and the visual effect can be improved.

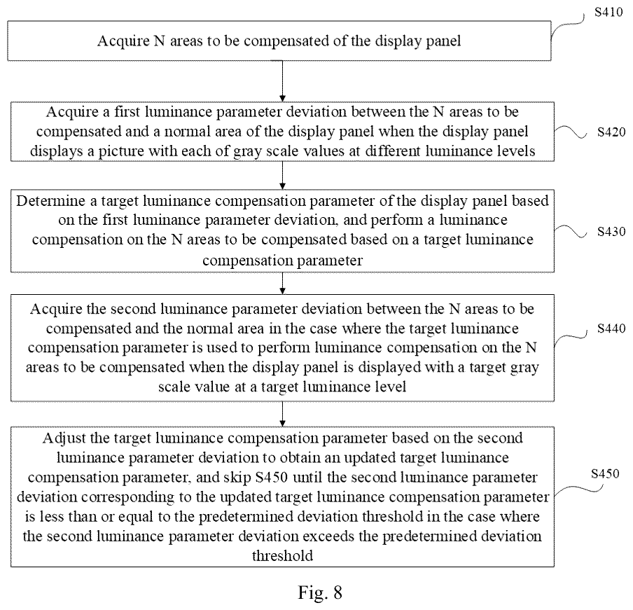

According to some embodiments of the present application, optionally, after determining a target luminance compensation parameter of the display panel based on the first luminance parameter deviation, and performing luminance compensation on the N areas to be compensated based on the target luminance compensation parameter, as shown in FIG. 8, the compensation method for the display panel further comprises the following loop steps:

In S440, the second luminance parameter deviation between the N areas to be compensated and the normal area is acquired in the case where the target luminance compensation parameter is used to perform luminance compensation on the N areas to be compensated when the display panel is displayed with a target gray scale value at a target luminance level.

In S450, the target luminance compensation parameter is adjusted based on the second luminance parameter deviation to obtain an updated target luminance compensation parameter, and S440 is skipped until the second luminance parameter deviation corresponding to the updated target luminance compensation parameter is less than or equal to the predetermined deviation threshold in the case where the second luminance parameter deviation exceeds the predetermined deviation threshold.

In this embodiment, in order to sufficiently improve the luminance compensation accuracy of the areas to be compensated, after the luminance compensation is performed on the N areas to be compensated based on the target luminance compensation parameter, when the display panel is displayed with the target gray scale value at the target luminance level, the second luminance parameter deviation between the N areas to be compensated and the normal area is tested and calculated again, so as to judge the luminance improvement of the areas to be compensated after the compensation. The target luminance level and the target gray scale value may be selected as desired, which may be one or more.

If it is found that there is still a significant luminance deviation between the area to be compensated and the normal area when the luminance test is performed again, the above-mentioned target luminance compensation parameter is further adjusted a second time. During the secondary adjustment, the updated target luminance compensation parameter can be determined according to the newly measured second luminance parameter deviation.

And so on, continuing to compensate the area to be compensated according to the updated target luminance compensation parameter, and then testing a second luminance parameter deviation between the area to be compensated and a normal area until the second luminance parameter deviation is less than or equal to a predetermined deviation threshold value. In this case, it can be considered that the compensation effect of the area to be compensated is better, and then the display luminance compensation is performed according to the corresponding target luminance compensation parameter. That is to say, in this embodiment, the target luminance compensation parameter of the initial edition of the area to be compensated is obtained through the luminance deviation between the split-screen area to be compensated and the normal area, and finally the visual effect and luminance is confirmed based on the compensation of the initial edition of the target luminance compensation parameter to the area to be compensated. Debugging is continuously performed, and finally, the optimal target luminance compensation parameter is obtained.

It should be noted that the preset deviation threshold may be, for example, 0.5 nit. The predetermined deviation threshold value can be specifically and flexibly set according to panel design indexes and user requirements, etc. and this is not strictly limited in the present application.

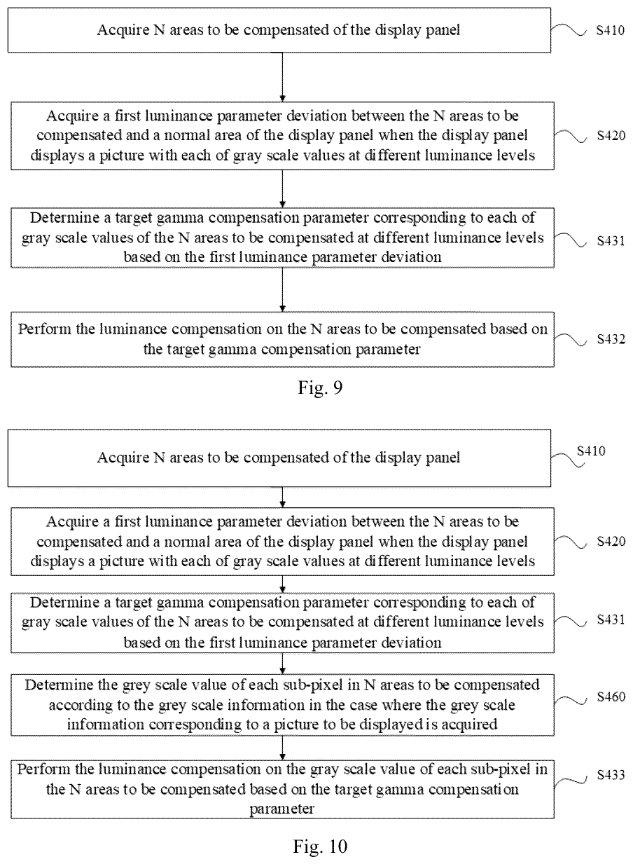

According to some embodiments of the present application, optionally, as shown in FIG. 9, the above-mentioned step 430: determining a target luminance compensation parameter of the display panel based on the first luminance parameter deviation, and performing the luminance compensation on N areas to be compensated based on the target luminance compensation parameter, specifically comprises S431 and S432.

In S431, a target gamma compensation parameter corresponding to each of gray scale values of the N areas to be compensated at different luminance levels is determined based on the first luminance parameter deviation;

In S432, the luminance compensation on the N areas to be compensated is performed based on the target gamma compensation parameter.

In this way, it is specifically defined that a target gamma compensation parameter corresponding to each of gray scale values at different luminance levels is determined according to the first luminance parameter deviation, so as to realize the luminance compensation for the N areas to be compensated through gamma compensation.

More specifically, optionally, the N areas to be compensated include a plurality of sub-pixels, and before performing the luminance compensation on the N areas to be compensated based on the target gamma compensation parameter, as shown in FIG. 10, the compensation method for the display panel further includes S460.

In S460, the grey scale value of each sub-pixel in N areas to be compensated is determined according to the grey scale information in the case where the grey scale information corresponding to a picture to be displayed is acquired.

In the above-mentioned S432: the luminance compensation on the N areas to be compensated is performed based on the target gamma compensation parameter, which can be replaced by S433.

In S433, the luminance compensation on the gray scale values of each sub-pixel in the N areas to be compensated is performed based on the target gamma compensation parameter.

In the present embodiment, in order to more accurately realize the luminance compensation for each area to be compensated during the actual panel display operation, the gamma compensation parameters required for each sub-pixel in the area to be compensated can be determined with respect to the gray scale value thereof. In this way, a point-to-point accurate compensation can be achieved for the gray scale values of different sub-pixels, so as to avoid a single compensation parameter being still used when sub-pixels in the area to be compensated display different pictures, thereby affecting the compensation effect.

It should be added that, in practical operation, the above-mentioned picture to be displayed may be a content or an image to be displayed by a display panel, such as an application program interface, etc. When the luminance is tested in an early stage, the picture to be displayed may refer to a specific pattern for testing and calibration, or a single color picture, etc. in order to measure and evaluate the luminance deviation.

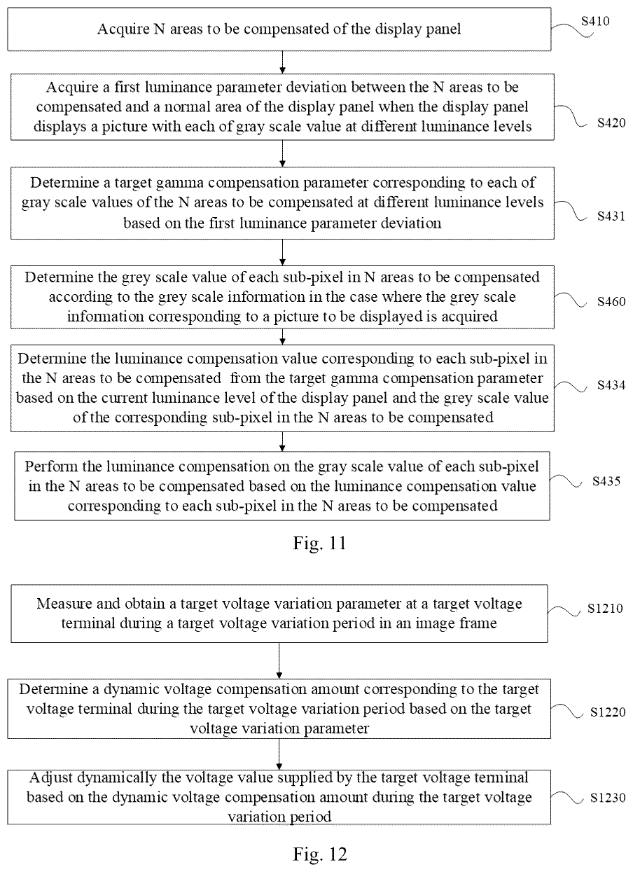

According to some embodiments of the present application, optionally, as shown in FIG. 11, the above-mentioned S433, in which the luminance compensation on the gray scale values of each sub-pixel in the N areas to be compensated is performed based on the target gamma compensation parameter, may be further replaced by S434 and S435.

In S434, the luminance compensation value corresponding to each sub-pixel in the N areas to be compensated is determined from the target gamma compensation parameters based on a current luminance level of the display panel and the grey scale value of the corresponding sub-pixel in the N areas to be compensated.

In S435, the luminance compensation is performed on the gray scale values of each sub-pixel in the N areas to be compensated based on the luminance compensation values corresponding to each sub-pixel in the N areas to be compensated.

In the present embodiment, the actual luminance level of the current display panel and the gray scale values of each sub-pixel in the area to be compensated are integrated, and the luminance compensation values corresponding to each sub-pixel in the area to be compensated with different luminance levels are determined according to the target gamma compensation parameter.

In this way, the sub-pixels in the area to be compensated have their corresponding luminance compensation values at different luminance levels and gray levels. After compensated, the grey scale value of the sub-pixel is converted into a corresponding data voltage and is transmitted to a pixel circuit, so that the sub-pixel performs light-emitting display according to the compensated grey scale value, thus achieving accurate gamma compensation for the sub-pixel in the area to be compensated.

According to some embodiments of the present application, optionally, as shown in FIG. 12, the compensation method for the display panel further includes S1210, S1220, and S1230.

In S1210, a target voltage variation parameter at a target voltage terminal is measured and obtained during a target voltage variation period in an image frame. The target voltage terminal is configured to provide the target voltage to the sub-pixels in a target stage. The target voltage is associated with the light emission luminance of the sub-pixels in the display panel, and the target voltage variation period is a period where a virtual pixel row in the target stage in the display blanking area exists.

In S1220, a dynamic voltage compensation amount corresponding to the target voltage terminal during the target voltage variation period is determined based on the target voltage variation parameter.

In S1230, the voltage value supplied by the target voltage terminal is dynamically adjusted based on the dynamic voltage compensation amount during the target voltage variation period, so as to perform luminance compensation on the N areas to be compensated.

In the present embodiment, in S1210, the target voltage terminal is configured to supply the target voltage to the sub-pixel in the target stage. The target voltage terminal, such as a reset voltage terminal or a bias voltage terminal. can be arranged on the display area of the display panel for providing a target voltage for one or more rows of sub-pixels. The target voltage includes a reset voltage supplied to a light-emitting device in the sub-pixel and may also include a bias voltage supplied to a first terminal or a second terminal of a driving module in a pixel circuit of the sub-pixel. Both the reset voltage and the bias voltage affect the final luminance of the light-emitting device.

The above-mentioned target voltage variation period is a period where a virtual pixel row in the target stage in the display blanking area exists. During this target voltage variation period, the in-plane load of the display panel varies due to the presence of the display blanking area, causing the above-mentioned target voltage (e.g. reset voltage, bias voltage) to fluctuate, thereby causing the display panel to appear dark striae in the area to be compensated.

More specifically, in one image frame, there are N target voltage variation periods. There are also N areas to be compensated, and the target voltage terminal is configured to supply a target voltage to the sub-pixel in the area to be compensated at the target stage. Therefore, at the target stage, the target voltage supplied by the target voltage terminal to the sub-pixel in the area to be compensated fluctuates due to the in-plane load variation of the panel, thereby causing the area to be compensated to appear dark striae. In different image frames, the time region of the target voltage variation period is fixed.

In this embodiment, in the target voltage variation period, the voltage fluctuation at the target voltage terminal in this period is measured using a voltage measuring device such as an oscilloscope, so as to obtain the target voltage variation parameter at the target voltage terminal. Taking the example where the target voltage terminal is the reset voltage terminal, the target voltage variation parameter may be a variation in the voltage value of the reset voltage supplied by the reset voltage terminal during the target voltage variation period.

In S1220, the dynamic voltage compensation amount corresponding to the target voltage terminal is determined based on the measured target voltage variation parameter during the target voltage variation period.

For example, if the target voltage variation parameter indicates that the voltage value supplied by the target voltage terminal fluctuates and decreases within the target period, the relationship between the decrease degree of the specific voltage value and the time can be determined, and the dynamic voltage compensation amount is obtained. The dynamic voltage compensation amount may be a correspondence relationship between the voltage compensation value and the target voltage variation period.

In S1230, the voltage value supplied by the target voltage terminal is dynamically adjusted based on the dynamic voltage compensation amount during the target voltage variation period in the subsequent image frame. In this way, the luminance compensation for the N areas to be compensated is realized by testing the voltage fluctuation and dynamically adjusting the voltage value supplied by the target voltage terminal according to the voltage variation.

Furthermore, it should be noted that in the present embodiment, considering that the in-plane load is dynamically varied, since the voltage value is compensated in a dynamic adjustment manner, an overcompensation or under-compensation situation in the voltage compensation process can be effectively avoided, thereby affecting the compensation effect.

According to some embodiments of the present application, and more particularly, in connection with an actual pixel circuit initialization operating scenario, the target voltage terminal includes a reset voltage terminal for supplying a reset voltage to the sub-pixel during a reset stage.

The target voltage variation period includes a reset voltage variation period, which is a period where a virtual pixel row in the reset stage in the display blanking area exists.

The target voltage variation parameter includes a reset voltage variation parameter which includes dynamic variation information of a reset voltage at a reset voltage terminal during a reset voltage variation period. The dynamic voltage compensation amount includes a reset voltage compensation amount.

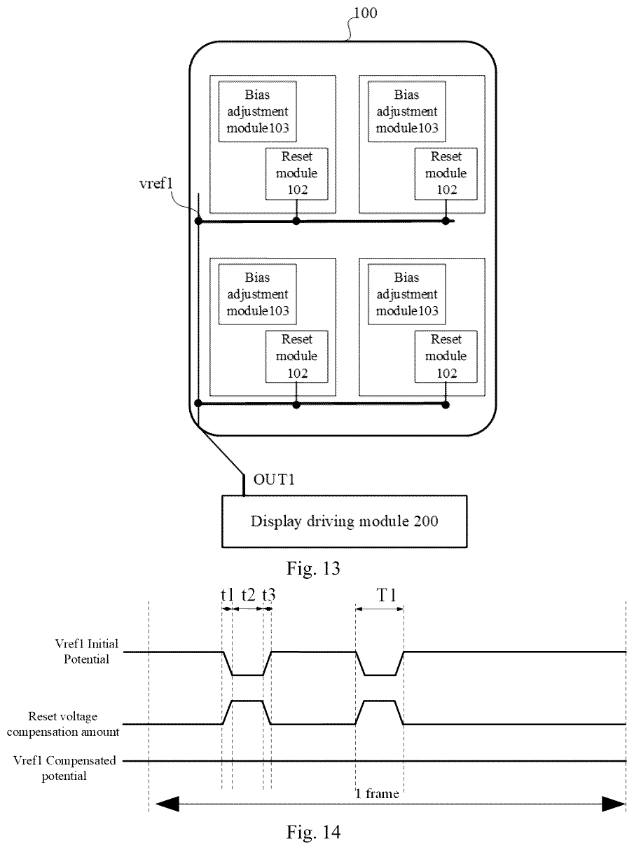

According to some embodiments of the present application, optionally, as shown in FIG. 13, the display panel 100 is electrically connected to the display driving chip 200, and the reset voltage output terminal OUT1 of the display driving chip 200 is electrically connected to the reset voltage terminal vref1 corresponding to each sub-pixel in the N regions to be compensated via traces. The step of adjusting dynamically the voltage value supplied by the target voltage terminal based on the dynamic voltage compensation amount during the target voltage variation period includes adjusting dynamically the voltage value of the voltage output from the reset voltage output terminal of the display driving chip based on the reset voltage compensation amount during the reset voltage variation period to adjust the voltage value of the reset voltage supplied by the bias voltage terminal vref2 to the sub-pixel.

In the present embodiment, the display driving chip 200 (Display Driver IC) plays a crucial role in the operation of the display panel 100 and is responsible for controlling the functions of pixel driving, gray scale control, luminance adjustment, etc. of the display panel 100. The reset voltage is generally generated by a circuit inside the display driving chip 200 and is output to a reset voltage terminal vref1 in the display panel by a reset voltage output terminal OUT via the trace.

The reset voltage terminal vref1, unlike the reset voltage output terminal OUT1 of the display driving chip 200, is a terminal provided in the display panel 100. The value of the voltage output from the reset voltage output terminal OUT1 is generally constant. While the reset voltage terminal vref1 is set in the in-plane, the voltage value directly supplied to the sub-pixel is affected by the in-plane load variation due to the trace and the display blanking area.

In specific implementation, a voltage value of an output voltage at a reset voltage output terminal OUT1 of the display driving chip 200 is dynamically adjusted according to the reset voltage compensation amount during a reset voltage variation period. In this way, it is possible to effectively adjust the voltage value of the reset voltage supplied by the reset voltage terminal vref1 to the sub-pixel.

According to some embodiments of the present application, optionally, referring to FIG. 14, in order to realize dynamic compensation adjustment of the sub-pixel reset voltage more reasonably, the step of adjusting dynamically the voltage value of the voltage output from the reset voltage output terminal of the display driving chip based on the reset voltage compensation amount during the reset voltage variation period T1 includes:
Dynamically increasing the voltage value of the voltage output from the reset voltage output terminal OUT1 of the display driving chip 200 based on the reset voltage compensation amount in a first sub-period t1 of the reset voltage variation period t1;
Maintaining the voltage value of the voltage output from the reset voltage output terminal OUT1 of the display driving chip 200 at the maximum voltage value during the first sub-period t1 based on the reset voltage compensation amount during a second sub-period t2 of the reset voltage variation period t1; and
Reducing dynamically, from the maximum voltage value as a start point the voltage value of the voltage output from the reset voltage output terminal OUT1 of the display driving chip 200, based on the reset voltage compensation amount, during a third sub-period t3 of the reset voltage variation period T1.

Here, the first sub-period t1, the second sub-period t2, and the third sub-period t3 follow one another sequentially.

In specific implementation, in conjunction with the above-mentioned examples, considering that the in-plane load variation is a dynamic variation process, the first sub-period t1 is actually a period during which the virtual sub-pixel in the reset stage in the display blanking area gradually increases from 0 row to 90 rows. The second sub-period t2 is a period during which the virtual sub-pixel in the reset stage in the display blanking area is fixed to 90 rows. The third sub-period t3 is a period during which the virtual sub-pixel in the reset stage in the display blanking area gradually decreases from 90 rows to 0 row.

During the first sub-period t1, since the row number of the virtual pixel rows at the reset stage in the display blanking area is continuously increasing, the in-plane load is gradually decreasing, the reset voltage received by the sub-pixel is gradually decreasing under the influence of the load, and the negative pressure is more negative. During this period, the compensation for the reset voltage received by the sub-pixel can be achieved by dynamically increasing the voltage value output from the reset voltage output terminal OUT1 of the display driving chip 200.

During the second sub-period t2, a virtual pixel row having a fixed number of rows always exists in the display blanking area in the reset stage, so that it suffices to keep the voltage value output from the reset voltage output terminal OUT1 of the display driving chip 200 stable in this period, the voltage value being the maximum voltage value during the first sub-period t1.

During the third sub-period t3, since the row number of the virtual pixel rows in the reset stage in the display blanking area is continuously reduced, the in-plane load is gradually increased to return to normal, and the voltage fluctuation to which the reset voltage received by the sub-pixel is subjected is gradually reduced. Therefore, in this period, the voltage value of the voltage output from the reset voltage output terminal OUT1 of the display driving chip 200 is dynamically decreased, thereby achieving dynamic and accurate compensation of the reset voltage.

In this embodiment, according to the variation time region and variation amount of the reset voltage, the display driving chip is allowed to perform accurate voltage compensation in the variation time region to enable the reset voltage stable, thereby effectively guaranteeing the consistency of the reset degree of the anode, avoiding the problem of non-uniform luminance display with split-screen caused by the different reset degrees of the anode, and thus improving the visual effect.

According to some embodiments of the present application, and more particularly, in connection with an actual pixel circuit bias adjustment scenario, the target voltage terminal includes a bias voltage terminal for supplying a bias adjustment voltage to the sub-pixels during a bias adjustment stage.

The target voltage variation period includes a bias voltage variation period which is a period where a virtual pixel row in the bias adjustment stage in the display blanking area exists.

The target voltage variation parameter includes a bias voltage variation parameter, which includes dynamic variation information of a bias adjustment voltage at a bias voltage terminal during a bias voltage variation period. The dynamic voltage compensation amount includes a bias voltage compensation amount.

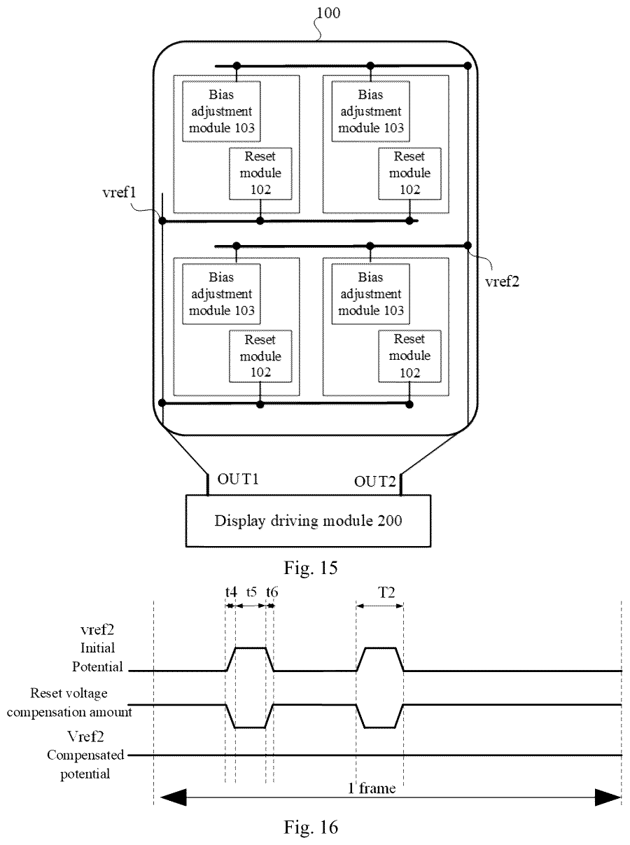

According to some embodiments of the present application, more specifically, as shown in FIG. 15, the display panel 100 is electrically connected to the display driving chip 200, and the bias voltage output terminal OUT2 of the display driving chip 200 is electrically connected to the bias voltage terminal vref2 corresponding to each sub-pixel in the N areas to be compensated via traces. The step of adjusting dynamically the voltage value supplied by the target voltage terminal based on the dynamic voltage compensation amount includes:

Adjusting dynamically the voltage value of the voltage output from the bias voltage output terminal OUT2 of the display driving chip 200 based on the bias voltage compensation amount during the bias voltage variation period T2, so as to adjust the voltage value of the bias voltage supplied by the bias voltage terminal vref2 to the sub-pixel.

In the present embodiment, the display driving chip 200 (Display Driver IC) plays a crucial role in the operation of the display panel 100 and is responsible for controlling the functions of pixel driving, gray scale control, luminance adjustment, etc. of the display panel 100. The bias voltage is generally generated by a circuit inside the display driving chip 200 and is output to the display panel 100 by the bias voltage output terminal OUT2 via the trace.

The bias voltage terminal vref2, unlike the bias voltage output terminal OUT2 of the display driving chip 200, is a terminal provided in the display panel 100. The value of the voltage output from the bias voltage output terminal OUT2 is generally stable. While the bias voltage terminal vref2 is set in the in-plane, the voltage value directly supplied to the sub-pixel is affected by the in-plane load variation due to the trace and the display blanking area.

In specific implementation, the voltage value of the voltage output from the bias voltage output terminal OUT2 of the display driving chip 200 is dynamically adjusted according to the bias voltage compensation amount during the bias voltage variation period T2. In this way, the voltage value of the bias voltage supplied by the bias voltage terminal vref2 to the sub-pixel can be effectively adjusted.

According to some embodiments of the present application, optionally, as shown in FIG. 16, in order to realize dynamic compensation adjustment of a sub-pixel bias voltage more reasonably, the step of adjusting dynamically the voltage value of the voltage output from the bias voltage output terminal OUT2 of the display driving chip 200 based on the bias voltage compensation amount during the bias voltage variation period T2 includes:
Reducing dynamically the voltage value of the voltage output from the bias voltage output terminal OUT2 of the display driving chip 200 based on the bias voltage compensation amount during a fourth sub-period t4 of the bias voltage variation period T2;
Maintaining the voltage value of the voltage output from the bias voltage output terminal OUT2 of the display driving chip 200 at the minimum voltage value during the fourth sub-period t4, based on the bias voltage compensation amount, during a fifth sub-period t5 of the bias voltage variation period T2;
Dynamically increasing, from the minimum voltage value as a start point. the voltage value of the voltage output from the bias voltage output terminal OUT2 of the display driving chip 200, based on the bias voltage compensation amount, during a sixth sub-period t6 of the bias voltage variation period T2.

The fourth sub-period t4, the fifth sub-period t5, and the sixth sub-period t6 follow one another sequentially.

In specific implementation, during the fourth sub-period t4, since the row number of virtual pixel rows in the bias adjustment stage in the display blanking area increases continuously, the in-plane load gradually decreases, the bias voltage received by the sub-pixel gradually increases under the influence of the load, and the positive voltage becomes more positive. During this period, the bias voltage received by the sub-pixel can be compensated by dynamically reducing the voltage value output from the bias voltage output terminal OUT2 of the display driving chip 200.

During the fifth sub-period t5, a virtual pixel row having a fixed number of rows always exists in the bias adjustment stage in the display blanking area, so it suffices to keep the voltage value output from the bias voltage output terminal OUT2 of the display driving chip 200 stable during this period, the voltage value being the minimum voltage value during the fourth sub-period t4.

During the sixth sub-period t6, since the row number of the virtual pixel rows in the bias adjustment stage in the display blanking area is continuously reduced, the in-plane load gradually increases to return to normal, and the voltage fluctuation to which the bias voltage received by the sub-pixel is subjected gradually decreases. Therefore, in this period, the voltage value of the voltage output from the bias voltage output terminal OUT2 of the display driving chip 200 is dynamically increased from the minimum voltage value, thereby achieving dynamic and accurate compensation of the bias voltage.

It is added that when the reset stage of the sub-pixel is the same as the bias adjustment stage, the first sub-period is the same as the fourth sub-period t4, the second sub-period is the same as the fifth sub-period t5, and the third sub-period is the same as the sixth sub-period t6.

In this embodiment, according to the variation time region and the variation amount of the bias voltage, the display driving chip 200 is allowed to perform accurate bias voltage compensation in the variation time region to enable the bias voltage stable, thereby contributing to improving the split-screen display problem of the display panel 100 and improving the visual effect.

In some embodiments, after the luminance compensation is performed on the area to be compensated using the voltage dynamic compensation, further debugging can be performed through visual confirmation based on the initial edition reset voltage compensation amount and/or the bias voltage compensation amount to determine the optimal compensation amount of the display driving chip voltage.

In the case where the display panel is voltage-compensated based on the above-described preliminary reset voltage compensation amount and/or the bias voltage compensation amount at the time of the visualization confirmation, the luminance deviation between the N areas to be compensated and the normal area is retested by allowing the display panel to be displayed at the target gray scale value at the target luminance level in embodiments of the present application.

If the luminance deviation meets the requirements, it indicates that the panel compensation effect is better. If the luminance deviation does not meet the requirement, the reset voltage compensation amount and/or the bias voltage compensation amount may continue to be adjusted based on the luminance deviation. After adjustment, continue to make a new round of visual confirmation, until the luminance deviation between the area to be compensated and the normal area obtained by testing meets the requirements. In this way, it is possible to sufficiently secure the compensation effect of the voltage compensation amount, thereby contributing to a significant improvement in visual effect.

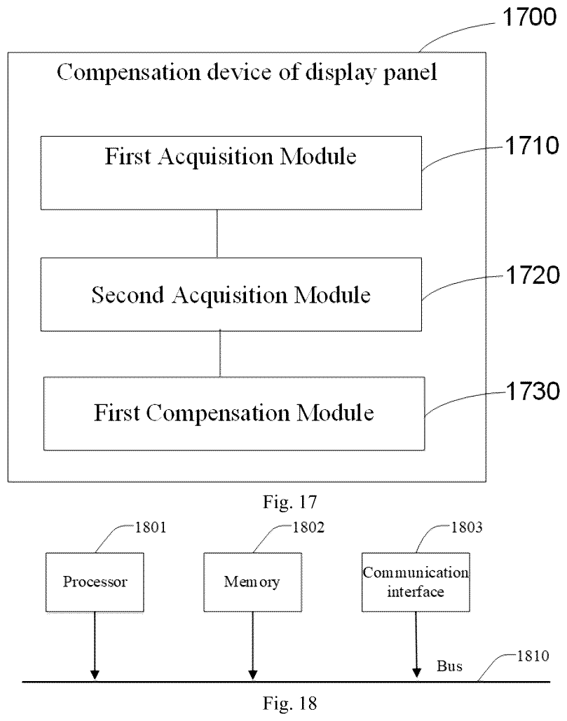

Based on the display panel compensation method provided by the above-mentioned embodiment, accordingly, the present application further provides a compensation device for a display panel corresponding to the above-mentioned display panel compensation method, and the display panel compensation device will be described in detail with reference to FIG. 17.

FIG. 17 is a schematic structural view of a compensation device for a display panel according to an embodiment of the present application. As shown in FIG. 17, the compensation device 1700 for the display panel includes a first acquisition module 1710, a second acquisition module 1720, and a first compensation module 1730.

The first acquisition module 1710 is configured to acquire N areas to be compensated of a display panel. The N areas to be compensated are determined and obtained based on a target scanning timing and a display blanking area of the display panel, where N being a positive integer. The target scanning timing includes at least one of a first scanning timing and a second scanning timing, the first scanning timing being configured for resetting and scanning of the sub-pixels in the display panel, and the second scanning timing being configured for bias adjustment and scanning of a driving module in the sub-pixel.

The second acquisition module 1720 is configured to acquire the first luminance parameter deviations between the N areas to be compensated and the normal area of the display panel when the display panel displays a picture with each of gray scale values at different luminance levels.

The first compensation module 1730 is configured to determine a target luminance compensation parameter of the display panel based on the first luminance parameter deviation and to perform luminance compensation on the N areas to be compensated based on the target luminance compensation parameter.

Each module/unit in the device shown in FIG. 17 has the function of realizing each step in the compensation method for the display panel provided by the above embodiments of the method, and can achieve its corresponding technical effect. For the sake of brevity, the description thereof will not be repeated here.

Based on the display panel compensation method provided by the above-mentioned embodiments of the present application, a compensation apparatus for a display panel provided by the present application will be described below. Refer to FIG. 18, which is a schematic structural view of a compensation apparatus for a display panel according to an embodiment of the present application.

As shown in FIG. 18, the compensation apparatus for the display panel may include a processor 1801 and a memory 1802 in which computer program instructions are stored.

In particular, the processor 1801 described above may include a central processing unit (CPU) or an application specific integrated circuit (ASIC), or may be configured to implement one or more integrated circuits of embodiments of the present application.

Memory 1802 may include mass storage for data or instructions. By way of example, and not limitation, memory 1802 may include a Hard Disk Drive (HDD) drive, a floppy disk drive, a flash memory, an optical disk, a magneto-optical disk, a magnetic tape, or a Universal Serial Bus (USB) drive, or a combination of two or more of the foregoing. Where appropriate, the memory 1802 may include removable or non-removable (or fixed) media. Where appropriate, the memory 1802 may be internal or external to the integrated gateway disaster tolerance device. In a particular embodiment, memory 1802 is a non-volatile solid-state memory.

The memory may include a read only memory (ROM), a random access memory (RAM), a magnetic disk storage media device, an optical storage media device, a flash memory device, an electrical, optical or other physical/tangible memory storage device. Thus, in general, a memory includes one or more tangible (non-transitory) computer-readable storage media (e.g. a memory device) encoded with software comprising computer-executable instructions, and the software, when executed (e.g. by one or more processors), is operable to perform the operations described with reference to a method according to an aspect of the present application.

The processor 1801 implements the compensation method for the display panel of any of the above-described embodiments by reading and executing computer program instructions stored in the memory 1802.

In one example, the compensation apparatus of the data display panel may further include a communication interface 1803 and a bus 1810. As shown in FIG. 18, a processor 1801, a memory 1802, and a communication interface 1803 are connected via a bus 1810 and communicate with each other.

The communication interface 1803 is mainly configured to realize communication between various modules, devices, units and/or devices in the embodiment of the present application.

The bus 1810 includes hardware, software, or both, to couple the components of the compensation apparatus of the display panel to each other. By way of example, and not limitation, a bus may include an accelerated graphics port (AGP) or other graphics bus, an enhanced industry standard architecture (EISA) bus, a front side bus (FSB), a Hyper Transport (HT) interconnect, an industry standard architecture (ISA) bus, an infinite bandwidth interconnect, a low pin count (LPC) bus, a memory bus, an MCA bus, a peripheral component interconnect (PCI) bus, a PCI-Express (PCI-X) bus, a serial advanced technology attachment (SATA) bus, a video electronics standards association local (VLB) bus, or other suitable bus, or a combination of two or more of these. Bus 1810 may comprise one or more buses, where appropriate. Although embodiments of the present application describe and illustrate particular buses, any suitable bus or interconnect is contemplated by the present application.

The compensation apparatus for the display panel performs the compensation method of the display panel in embodiments of the present application, thereby implementing the compensation method for the display panel provided in any one or more of the above-mentioned method embodiments.

In addition, in conjunction with the display panel compensation method in the above-described embodiments, embodiments of the present application can provide a computer storage medium to be implemented. A computer program instruction is stored on the computer storage medium; the computer program instructions, when executed by a processor, implement the compensation method of any one of the above embodiments of the display panel.

Based on the compensation method for the display panel in the above-described embodiments, embodiments of the present application provide a computer program product in which instructions, when executed by a processor of an electronic device, cause the electronic device to perform the display panel compensation method as provided in any of the above-described embodiments of the present application.

It is to be expressly understood that this application is not limited to the particular arrangements and instrumentalities described above and illustrated in the drawings. For the sake of brevity, a detailed description of known methods is omitted herein. In the embodiments described above, a number of specific steps have been described and shown as examples. However, the methodological processes of the present application are not limited to the specific steps described and illustrated, and various variations, modifications and additions, or sequences between steps may be made by those skilled in the art having the benefit of the teachings of the present application.

The functional blocks shown in the block diagrams described above may be implemented in hardware, software, firmware, or a combination thereof. When implemented in hardware, it may be, for example, an electronic circuit, an application specific integrated circuit (ASIC), appropriate firmware, a plug-in, a function card, etc. When implemented in software, the elements of the present application are the programs or code segments used to perform the required tasks. The program or code segments may be stored in a machine-readable medium or transmitted over a transmission medium or communication link by a data signal carried in a carrier wave. A “machine-readable medium” may include any medium that can store or transmit information. Examples of a machine-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The code segments may be downloaded via a computer network, such as the Internet, an intranet, or the like.

It should also be noted that the exemplary embodiments mentioned in this application describe methods or systems based on a series of steps or apparatuses. However, the present application is not limited to the order of the steps described above, that is, the steps may be performed in the order mentioned in the embodiments, may be performed in an order different from that in the embodiments, or several steps may be performed at the same time.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such a processor may be, but is not limited to, a general purpose processor, a special purpose processor, an application specific processor, or field programmable logic. It will also be understood that each block of the block diagrams and/or flowchart illustrations, and combinations of blocks in the block diagrams and/or flowchart illustrations, can also be implemented by special purpose hardware that performs the specified functions or acts, or combinations of special purpose hardware and computer instructions.

While the foregoing is directed to particular embodiments of the present application, it will be appreciated by those skilled in the art that various variations in the form and details of the system, modules and units described herein may be made without departing from the spirit and scope of the present application. It should be understood that the scope of the present application is not limited thereto, and that various equivalent modifications and alterations may be readily suggested to one skilled in the art within the scope of the present application, and such modifications and alterations are intended to be included herein.

What is claimed is:

1. A compensation method for a display panel comprising:
acquiring N areas to be compensated of the display panel, wherein the N areas to be compensated are determined and obtained based on a target scanning timing and a display blanking area of the display panel, where N is a positive integer; the target scanning timing comprises at least one of a first scanning timing and a second scanning timing, the first scanning timing being configured for resetting and scanning of a sub-pixel in the display panel, and the second scanning timing being configured for bias adjustment scanning of a driving module in the sub-pixel;
acquiring a first luminance parameter deviation between the N areas to be compensated and a normal area of the display panel when the display panel displays a picture with each of gray scale values at different luminance levels; and
determining a target luminance compensation parameter of the display panel based on the first luminance parameter deviation, and performing the luminance compensation on the N areas to be compensated based on the target luminance compensation parameter.

2. The method according to claim 1, wherein after determining a target luminance compensation parameter of the display panel based on the first luminance parameter deviation, and performing the luminance compensation on the N areas to be compensated based on the target luminance compensation parameter, the method further comprises performing, in cycles, steps which comprise:
acquiring a second luminance parameter deviation between the N areas to be compensated and the normal area in a case where the target luminance compensation parameter is used to perform luminance compensation on the N areas to be compensated, when the display panel is displayed with a target gray scale value at a target luminance level; and
adjusting the target luminance compensation parameter based on the second luminance parameter deviation to obtain an updated target luminance compensation parameter until the second luminance parameter deviation corresponding to the updated target luminance compensation parameter is less than or equal to the predetermined deviation threshold in the case where the second luminance parameter deviation exceeds the predetermined deviation threshold.

3. The method according to claim 1, wherein the determining a target luminance compensation parameter of the display panel based on the first luminance parameter deviation, and performing the luminance compensation on the N areas to be compensated based on the target luminance compensation parameter comprises:
determining a target gamma compensation parameters corresponding to each of the gray scale values of the N areas to be compensated at the different luminance levels based on the first luminance parameter deviation; and
performing the luminance compensation on the N areas to be compensated based on the target gamma compensation parameter.

4. The method according to claim 3, wherein the N areas to be compensated comprises a plurality of sub-pixels;
before the performing the luminance compensation on the N areas to be compensated based on the target gamma compensation parameter, the method further comprises:
determining the grey scale value of each sub-pixel in N areas to be compensated according to the grey scale information in the case where the grey scale information corresponding to a picture to be displayed is acquired;
the performing the luminance compensation on the N areas to be compensated based on the target gamma compensation parameter comprises:
performing the luminance compensation on the gray scale value of each sub-pixel in the plurality of sub-pixels in the N areas to be compensated based on the target gamma compensation parameter.

5. The method according to claim 4, wherein the performing the luminance compensation on the gray scale value of each sub-pixel in the N areas to be compensated based on the target gamma compensation parameter comprises:
determining the luminance compensation value corresponding to each sub-pixel in the N areas to be compensated from the target gamma compensation parameter based on a current luminance level of the display panel and the grey scale value of the corresponding sub-pixel in the N areas to be compensated; and
performing the luminance compensation on the gray scale value of each sub-pixel in the N areas to be compensated based on the luminance compensation value corresponding to the corresponding sub-pixel in the N areas to be compensated.

6. The method according to claim 1, wherein the display panel comprises a plurality of the sub-pixels arranged in an array, each of the plurality of sub-pixels comprising a pixel circuit and a light-emitting device, and the pixel circuit including a reset module;
a control terminal of the reset module is electrically connected to the first scanning signal line, a first terminal of the reset module is electrically connected to a corresponding reset voltage terminal, and a second terminal of the reset module is electrically connected to a corresponding light-emitting device; and
the first scanning timing is a scanning timing of the first scanning signal line.

7. The method according to claim 6, wherein the pixel circuit comprises:
a driving module configured to drive the light-emitting device to emit light; and
a bias adjustment module, wherein a control terminal of the bias adjustment module is electrically connected to a second scanning signal line, a first terminal of the bias adjustment module is electrically connected to a corresponding bias voltage terminal, and a second terminal of the bias adjustment module is electrically connected to a first terminal or a second terminal of the driving module,
wherein the second scanning timing is a scanning timing of the second scanning signal line.

8. The method according to claim 7, wherein the first scanning signal line is also served as the second scanning signal line;
the first scanning timing is the same as the second scanning timing.

9. The method according to claim 1, wherein an image frame of the display panel comprises a display active area and a display blanking area;
the N areas to be compensated comprises a plurality of pixel rows; and
the pixel rows in the N areas to be compensated are those pixel rows in the display active area that receive an active level of the target scanning timing in the case where the active level of the target scanning timing is scanned to the display blanking area.

10. The method according to claim 1, wherein the first scanning timing is the same as the second scanning timing; and
a number of active pulses in the first scanning timing or the second scanning timing in one image frame is N+1.

11. The method according to claim 1, further comprising:
measuring and obtaining a target voltage variation parameter at a target voltage terminal during a target voltage variation period in an image frame, the target voltage terminal being configured to provide the target voltage to the sub-pixels in a target stage, and the target voltage being associated with the light emission luminance of the sub-pixels in the display panel, a target voltage variation period being a period where a virtual pixel row in the target stage in the display blanking area exists;
determining a dynamic voltage compensation amount corresponding to the target voltage terminal during the target voltage variation period based on the target voltage variation parameter; and
adjusting dynamically the voltage value supplied by the target voltage terminal based on the dynamic voltage compensation amount during the target voltage variation period to perform luminance compensation on the N areas to be compensated.

12. The method according to claim 11, wherein the target voltage terminal comprises a reset voltage terminal configured to supply a reset voltage to the sub-pixel during a reset stage;
the target voltage variation period comprises a reset voltage variation period which is a period where the virtual pixel row in the reset stage in the display blanking area exists; and
the target voltage variation parameter comprises a reset voltage variation parameter which comprises dynamic variation information of the reset voltage at the reset voltage terminal during the reset voltage variation period; and
the dynamic voltage compensation amount comprises a reset voltage compensation amount.

13. The method according to claim 12, wherein the display panel is electrically connected to a display driving chip, and a reset voltage output terminal of the display driving chip is electrically connected to the reset voltage terminal corresponding to each sub-pixel in the N regions to be compensated via a trace;
the adjusting dynamically the voltage value supplied by the target voltage terminal based on the dynamic voltage compensation amount during the target voltage variation period comprises adjusting dynamically the voltage value of the voltage output from the reset voltage output terminal of the display driving chip based on the reset voltage compensation amount during reset voltage variation period to adjust the voltage value of the reset voltage supplied by the reset voltage terminal to the sub-pixel.

14. The method according to claim 13, wherein the adjusting dynamically the voltage value of the voltage output from the reset voltage output terminal of the display driving chip based on the reset voltage compensation amount during the reset voltage variation period includes:
increasing dynamically the voltage value of the voltage output from the reset voltage output terminal of the display driving chip based on the reset voltage compensation amount during a first sub-period of the reset voltage variation period;
maintaining the voltage value of the voltage output from the reset voltage output terminal of the display driving chip at a maximum voltage value during the first sub-period based on the reset voltage compensation amount during a second sub-period of the reset voltage variation period; and
dynamically reducing, from the maximum voltage value as a start point, the voltage value of the voltage output from the reset voltage output terminal of the display driving chip, based on the reset voltage compensation amount, during a third sub-period of the reset voltage variation period,
wherein the first sub-period, the second sub-period, and the third sub-period follow one another sequentially.

15. The method according to claim 11, wherein the target voltage terminal comprises a bias voltage terminal for supplying a bias adjustment voltage to the sub-pixels during a bias adjustment stage;
the target voltage variation period comprises a bias voltage variation period which is a period where a virtual pixel row in the bias adjustment stage in the display blanking area exists;
the target voltage variation parameter comprises a bias voltage variation parameter, which comprises dynamic variation information of the bias adjustment voltage at the bias voltage terminal during the bias voltage variation period; and
the dynamic voltage compensation amount comprises a bias voltage compensation amount.

16. The method according to claim 15, wherein the display panel is electrically connected to the display driving chip, and the bias voltage output terminal of the display driving chip is electrically connected to the bias voltage terminal corresponding to each sub-pixel in the N areas to be compensated via a trace;
the adjusting dynamically a voltage value supplied by the target voltage terminal based on the dynamic voltage compensation amount during the target voltage variation period comprises:
adjusting dynamically a voltage value of the voltage output from the bias voltage output terminal of the display driving chip based on the bias voltage compensation amount during the bias voltage variation period to adjust a voltage value of the bias voltage supplied by the bias voltage terminal to the sub-pixel.

17. The method according to claim 16, wherein the adjusting dynamically the voltage value of the voltage output from the bias voltage output terminal of the display driving chip based on the bias voltage compensation amount during the bias voltage variation period comprises:
reducing dynamically the voltage value of the voltage output from the bias voltage output terminal of the display driving chip based on the bias voltage compensation amount during a fourth sub-period of the bias voltage variation period;
maintaining the voltage value of the voltage output from the bias voltage output terminal of the display driving chip at a minimum voltage value during the fourth sub-period, based on the bias voltage compensation amount, during a fifth sub-period of the bias voltage variation period; and
dynamically increasing, from the minimum voltage value as a start point, the voltage value of the voltage output from the bias voltage output terminal of the display driving chip, based on the bias voltage compensation amount, during a sixth sub-period of the bias voltage variation period,
wherein the fourth sub-period, the fifth sub-period, and the sixth sub-period follow one another sequentially.

18. The method according to claim 11, wherein a number of the target voltage variation period in one image frame is N.

19. A compensation device for a display panel comprising:
a first acquisition module configured to acquire N areas to be compensated of the display panel, wherein the N areas to be compensated is determined and obtained based on a target scanning timing and a display blanking area of the display panel, where N being a positive integer; the target scanning timing comprises at least one of a first scanning timing and a second scanning timing, the first scanning timing being configured for resetting and scanning a plurality of sub-pixels in the display panel, and the second scanning timing being configured for bias adjustment and scanning a driving module in the sub-pixels;
a second acquisition module configured to acquire a first luminance parameter deviations between the N areas to be compensated and a normal area of the display panel when the display panel displays a picture with each of the gray scale values at different luminance levels; and
a first compensation module configured to determine a target luminance compensation parameter of the display panel based on the first luminance parameter deviation, and to perform luminance compensation on the N areas to be compensated based on the target luminance compensation parameter.

20. An electronic device comprising a processor, a memory, and a computer program stored in the memory and executable on the processor,
wherein a compensation method for a display panel is implemented when the computer program is executed by the processor;
wherein the method comprises:
acquiring N areas to be compensated of the display panel, wherein the N areas to be compensated are determined and obtained based on a target scanning timing and a display blanking area of the display panel, where N is a positive integer; the target scanning timing comprises at least one of a first scanning timing and a second scanning timing, the first scanning timing being configured for resetting and scanning of a sub-pixel in the display panel and the second scanning timing being configured for bias adjustment scanning of a driving module in the sub-pixel;
acquiring a first luminance parameter deviation between the N areas to be compensated and a normal area of the display panel when the display panel displays a picture with each of gray scale values at different luminance levels; and
determining a target luminance compensation parameter of the display panel based on the first luminance parameter deviation, and performing the luminance compensation on the N areas to be compensated based on the target luminance compensation parameter.
